(19) United States
(12) Patent Application Publication
(10) Pub. No.: US 2007/0273675 A1
(43) Pub. Date: Nov. 29, 2007

(54) IMAGE CAPTURE AND DISPLAY SYSTEM AND METHOD

(75) Inventor: James R. Wangler, El Cajon, CA (US)

Correspondence Address: PROCOPIO, CORY, HARGREAVES & SAVITCH LLP, 530 B STREET, SUITE 2100, SAN DIEGO, CA, 92101, US

(73) Assignee: ELEGANCE QUEST ENTERPRISES, LLC, El Cajon, CA (US)

(21) Appl. No.: 11/419,807

(22) Filed: May 23, 2006

(51) Int. Cl. G09G 5/00

(52) U.S. Cl. 345/204

(57) ABSTRACT

A combination image capture and display system has a display module with a combined mirror and display panel facing in a first direction, the panel having a mirror layer and an image display layer disposed behind at least a portion of the mirror layer, the display panel selectively operable to act as a mirror in a mirror mode or to display images in the image display layer in a display mode. A camera module is integrated with the display module and has a lens facing outwardly from the panel. A computer connected to the display module and camera module controls operation of the camera module to capture images and switching of the display module between the mirror and display modes.

### BACKGROUND

1. Field of the Invention

The present invention relates generally to image capture and display, and is particularly concerned with camera systems using computer technology for enhanced viewing capabilities.

2. Related Art

Digital cameras are commonly used in photography and pictures taken using such cameras can be downloaded to computers, stored, and viewed on a computer monitor. However, the display screen generally built into the digital camera is relatively small and normally does not allow for viewing more than one image.

Mirror devices are known which can be simultaneously used for display purposes by means of a built-in display screen such as a liquid crystal display (“LCD”) behind the mirror. Such a device is described, for example, in US Patent Application Publication No. 2005/0185278, entitled Mirror with Built-In Display.

### SUMMARY

The present invention provides an image capture and display system and method in which a camera module is integrated with a display module which has a mirrored display panel having a mirror layer and an image display layer disposed behind at least a portion of the mirror layer. The display panel is selectively operable to act as a mirror in a mirror mode and as an image display in a display mode. A computer is connected to the camera and display modules for controlling operation of the camera module to capture images and switching of the display module between the mirror and display modes. In the display mode, selected images are displayed in the image display screen of the panel.

The display module may have a flat panel display and the image display layer may be a liquid crystal display (“LCD”). The image display layer may extend over the entire area of the mirror panel or may extend over only a portion of the mirror panel. The computer may control the display panel so that only a portion of the panel acts as an image display in the display mode, while the remainder acts as a mirror. In one embodiment, the display module is controlled so that one half of the panel acts as a mirror and the other half acts to display a selected image alongside a mirror image. Alternatively, two different images may be displayed side-by-side in some cases.

The camera module may be a digital still camera or a combined video and still digital camera. In the latter case, the camera may be used in the video mode until a still picture is taken.

The display module may be a combination mirror and television monitor and the computer may control the image display panel to display television programs in a television mode, to display mirror images only in a mirror mode, and to display mirror images and images captured by the camera module in a display mode. The mirror panel may be a full length mirror where the system is designed to display images of a subject wearing different types of clothing. In this case, the display module may reflect an actual mirror image of the subject in one part of the panel alongside an archived image of the same subject wearing a different outfit, for comparison purposes.

According to another aspect of the present invention, an image capture and display method is provided, in which images are captured of subjects in an area within the field of view of a camera built into a mirrored display panel or screen. The captured images are stored, and selected images are displayed on the display panel in a display mode of the panel. Mirror images are reflected on the mirrored display panel in a mirror mode of the panel.

Different images may be displayed in different parts of the panel in the display mode. Advantageously, part of the panel may be in mirror mode to reflect an image of a subject alongside a displayed image in the display mode part of the panel. Virtual enhancements such as make-up, jewelry, hair styles, eyeglasses, clothing, surgical enhancement or the like may be applied to a stored original image to produce an enhanced image, and the enhanced image may be displayed alongside the original image or a reflected image for comparison purposes. This method will allow users to easily try out various different styles and accessories from their home or in a store, before making a final selection, without actually having to have their hair re-styled or make up applied. A similar technique may be used for room decor effects, landscaping, or the like, using a captured image of the original room or landscape and then applying various virtual enhancements for viewing by a customer before making a final decision.

According to another aspect of the present invention, an image capture and display method is provided, in which images of subjects are captured in an area within the field of view of a camera built into a display screen or panel of a combined television/image capture and display unit when the unit is operating in an image capture mode. The captured images are stored and are selectively displayed on the display panel in a display mode. Video images are displayed on the display panel when the unit is operating in a television mode. The area within the field of view of the camera is monitored for movement when the unit is operating in a security or monitor mode, and an image is captured and stored when movement is detected within the field of view in the security mode.

The display panel may be switched into a mirror mode to form reflected images when images are not being captured or displayed and the television is switched off. The security or monitor mode may be used either for security purposes or for advertising purposes. In the latter case, the unit may be positioned in a store or the like to capture images of potential customers. These images may then be enhanced and displayed. In the security case, the camera may be hidden, for example in a frame of the display panel.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram of an image capture and display system according to a first embodiment of the invention;

FIG. 2 is a flow diagram illustrating a method of capturing and displaying images using the system of FIG. 1;

FIG. 3A is a front view of a display screen of the system operating in one possible display mode;

FIG. 3B is a front view of the display screen of FIG. 3 operating in a different display mode;

FIG. 4A is a diagrammatic sectional view of the display screen in one embodiment of the invention;

FIG. 4B is a sectional view similar to FIG. 4A illustrating a modified display screen.

FIG. 4C is a sectional view similar to FIG. 4A illustrating another modified display screen;

FIG. 4D is a sectional view similar to FIG. 4A illustrating another modified display screen;

FIG. 4E is a front plan view illustrating another example of a display screen;

FIG. 4F is a front plan view illustrating another example of a display screen;

FIG. 5 is a network diagram illustrating communication between the image capture and display system of FIG. 1 and a remote server;

FIG. 6 is a flow diagram illustrating a method of capturing and enhancing images according to an embodiment of the invention;

FIG. 7 is a block diagram illustrating an image capture and display system according to another embodiment of the invention;

FIGS. 8A and 8B are block diagrams illustrating an image capture and display method using the system of FIG. 7.

FIG. 9 is a block diagram illustrating a image capture system according to another embodiment of the invention having a plurality of mobile image capture devices communicating with a central processing unit over a network;

FIG. 10 is a partial side elevation view of an exemplary mobile image capture unit which may be used in the system of FIG. 9.

FIG. 11 is a block diagram illustrating an example wireless communication device that may be used in connection with various embodiments described herein; and

FIG. 12 is a block diagram illustrating an example computer system that may be used in connection with various embodiments described herein.

### DETAILED DESCRIPTION

Certain embodiments as disclosed herein provide for an image capture and display system and method. For example, one method as disclosed herein allows for different images to be displayed simultaneously in different portions of a display screen, or one image to be displayed alongside a reflected image in a portion of the display screen acting as a mirror.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

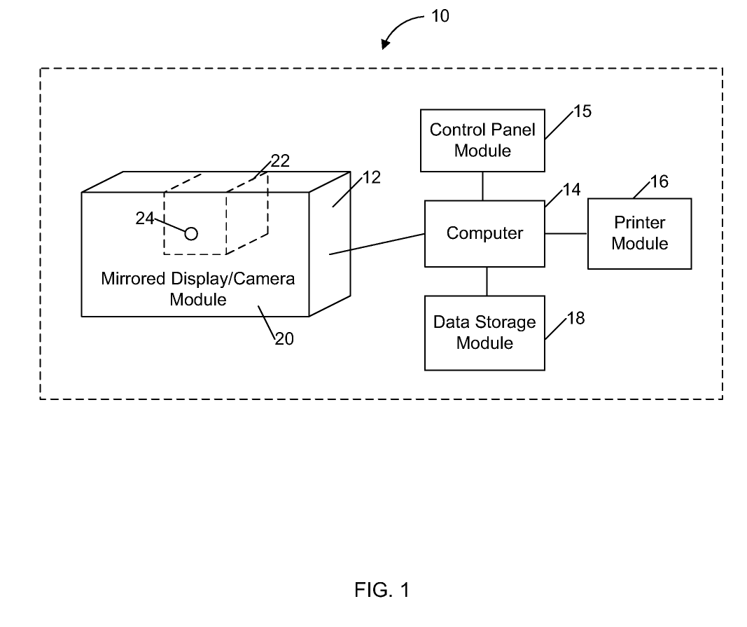

FIG. 1 is a block diagram illustrating an image capture and display system 10 according to an exemplary embodiment of the invention. The system comprises a display module 12 connected to a computer 14 for controlling operation of module 12, and a control panel module 15, printer module 16, and data storage module 18 associated with the computer 14. The display module 12 in FIG. 1 is a combination mirror/image display panel 20 having a built in digital camera module 22. The printer module may be a combination printer and scanner, or a separate scanner may be connected to computer 14 for scanning in images.

The digital camera module 22 may be built into a portion of the display module 12, as indicated in FIG. 1. The camera module may be a combination video and still digital camera. Camera module 22 has a forward facing camera lens 24 projecting through an opening in a region of panel 20. Lens 24 may be positioned in other locations in alternative embodiments, such as in a frame surrounding the panel. The panel 20 may be of any desired size, and may be a full length display panel or a smaller panel, depending on the application, as will be described in more detail below. In the exemplary embodiment, the display module is of a size which allows the digital camera and computer to be integrated into the display module, along with other associated peripheral devices such as the control panel module, data storage module and printer module, if desired. A remote control module may alternatively be provided for wired or wireless communication with the other modules of the system.

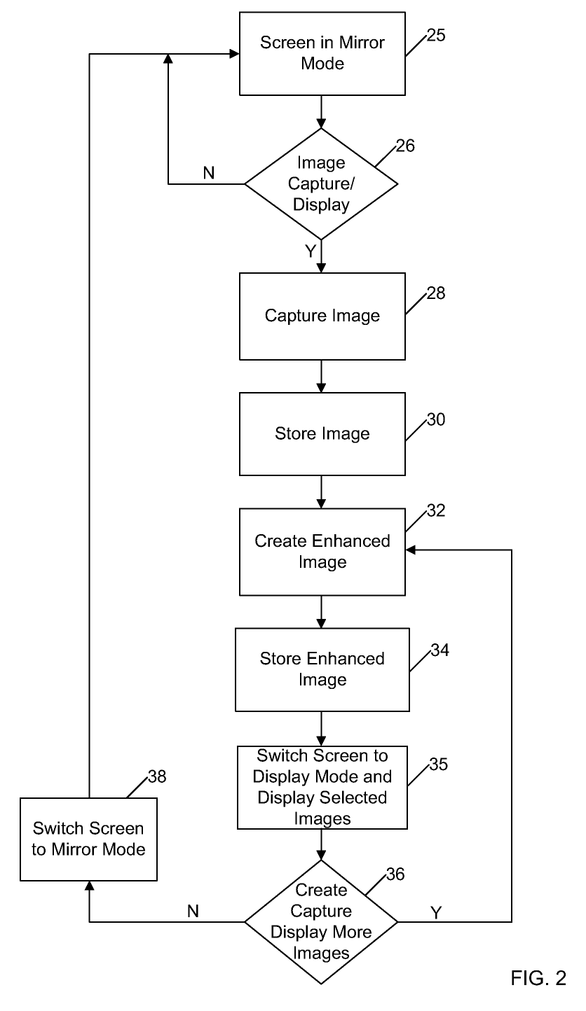

The mirrored display panel 20 is a combination mirror and image display panel which may operate in a mirror mode, a display mode, or a combination of mirror and display modes in different regions of the panel. FIG. 2 is a flow diagram illustrating one method of operating the system of FIG. 1. Initially, the display panel 20 is in a mirror mode 25 so that the entire panel operates as a conventional mirror and reflects images of objects in its field of view. If images are to be captured with the camera module 22, the system is initiated (26), and one or more images are captured with the camera module (28). Each captured image is stored (30). Where the camera is a combined video and still camera, the camera may be used in the video mode until a still picture is snapped or captured.

An enhanced image is then created (32). In one embodiment of the invention, the enhanced image is created by applying enhancements directly to the subject of the original image, and then capturing another image of the subject. This may be done, for example, in a store or business by applying make-up, jewelry, eyeglasses, changing hairstyles or wigs, different clothing, or the like. One or more enhanced images of the subject are then captured, for example to show different hairstyles, clothing, eyeglasses, or the like.

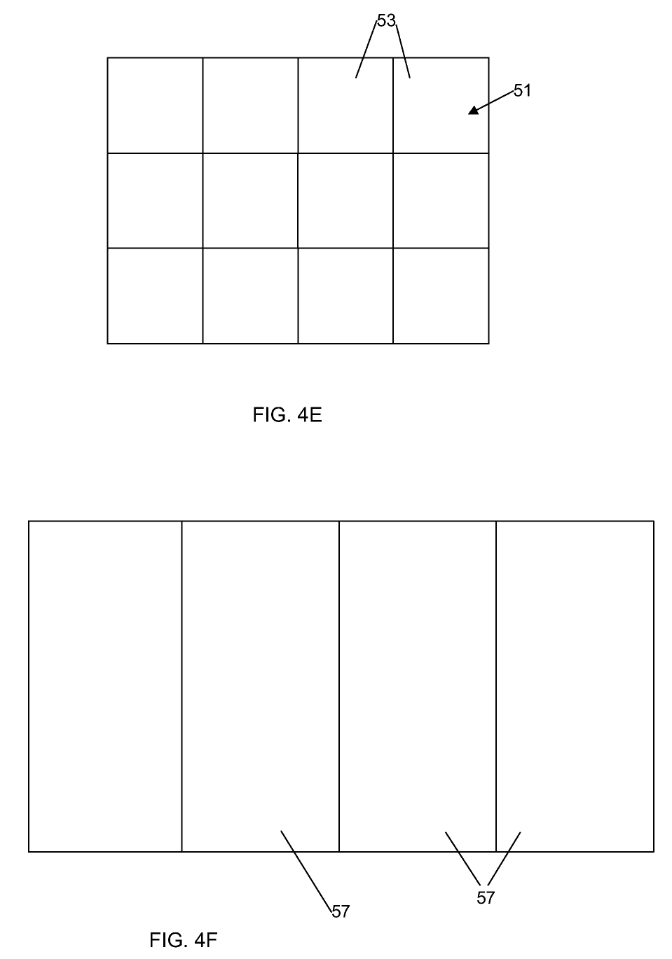

In another embodiment of the invention, the enhanced image is created by computer software in computer module 14 which applies virtual enhancements to the original image as directed by an operator via the control module 15. The virtual enhancements may be of any desired nature, such as make-up, hair color and style, eyeglasses, clothing, jewelry, body size adjustments, and the like. The enhancements may be stored in local data storage of the computer module 14. Alternatively, such enhancements may be obtained from a remote server 55 over the Internet 54, as indicated in FIG. 5. Enhancements may also be obtained from images scanned in on the printer/scanner module 16 or a separate scanner module.

Another method of enhancing an image is to scan in an image having a desired enhancement, such as a hairdo, and then move the hairdo onto the original image to create the enhanced image.

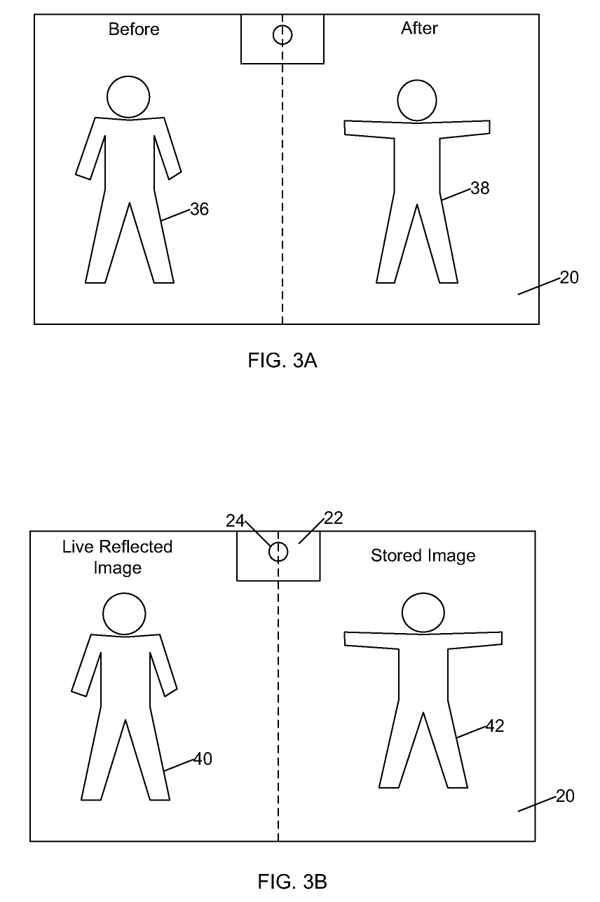

The enhanced image is then stored (34). The stored images may be real or virtually enhanced images, or both types of enhanced image may be created and stored. The screen may then be switched to a display mode in order to display selected images (35). FIGS. 3A and 3B illustrate some examples of how the images may be displayed. In FIG. 3A, an original or “before” image 36 is displayed on the left hand side of the display screen while an enhanced or “after” image 38 is displayed on the right hand side. In FIG. 3B, the left hand half of the screen is in a mirror mode and reflects an image 40 of a person standing in front of the screen, while the right hand half of the screen is in a display mode and displays a selected stored image 42 of the person, which may be an enhanced image.

When no more images are to be captured, created, or displayed (36), the system may be switched back to a full mirror mode (38). The camera may be activated to capture images while the panel is in a mirror mode.

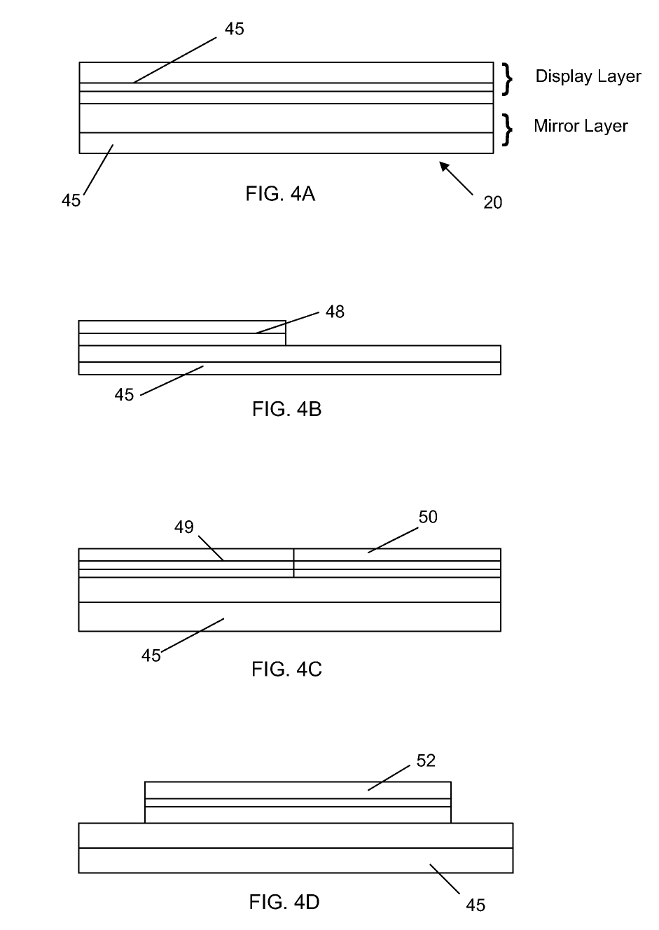

As noted above, the mirrored display panel 20 is a combination mirror and image display panel or screen. As illustrated in FIG. 4A, the display panel may comprise a front mirror layer 45 with a display layer 46 behind the mirror layer. The display layer may be a liquid crystal display (“LCD”), for example. In this example, the entire panel 20 acts as a mirror when in the mirror mode, and the entire panel acts as a display panel to display images when the display module is in the display mode. The mirror layer 45 does not disturb the transmission of light from the display 46 when the display layer is in operation, but will act as a conventional mirror to reflect light when in the mirror mode.

In the alternative of FIG. 4B, a smaller display layer 48 which extends over only half of the area of the mirror layer 45 is disposed behind the mirror layer. This means that half of the panel 20 still acts as a conventional mirror even when the panel is in a display mode and images are displayed by display layer 48. This option is illustrated in FIG. 3B.

FIG. 4C illustrates the alternative in which two half display layers 49, 50 are disposed behind mirror layer 45. In this embodiment, either half display layer 49, 50 may be activated under the control of computer 14 to display images with the other half of the panel 20 acting as a mirror, as in FIG. 3B, or both halves may be activated to display images simultaneously, as in FIG. 3A. Again, the entire display panel 20 will act as a mirror when the display layers are in mirror mode.

FIG. 4D illustrates an option in which a display layer 52 of smaller dimensions than the mirror layer 45 is disposed in a central position behind mirror layer 45, so that a mirrored periphery will extend around the entire display layer 52 when it is displaying images.

FIG. 4E illustrates an optional display panel or screen 51 which has a grid of separately controlled display areas 53 which can be selectively engaged under the control of computer 14 to operate either in a display mode or a mirror mode. Thus, different areas can be controlled to display images in a display mode while other areas operate in a mirror mode, allowing plural displayed and reflected images to be displayed simultaneously, if desired, or allowing differently positioned and shaped areas of the panel to operate in the display and mirror modes.

FIG. 4F illustrates another alternative display panel which has four display areas 57 arranged side-by-side. It will be understood that many alternative sectional arrangements of separately controlled display areas may be provided, allowing many alternative combinations or patterns of different display and mirror areas.

The display layer in any of the above embodiments may be configured to display only one image or more than one image simultaneously. The display panel may be of any desired shape such as square, rectangular, oval, round or the like, and the display layer may be of similar shape or of different shape. In the embodiment of FIG. 4D the overall display panel 20 may be oval while the display layer is square or rectangular, for example.

There are many possible applications for the image capture and display system of FIGS. 1 to 4, in stores, businesses and in the home. For example, the system may be used in a department store having a make-up department. The mirrored panel 20 will act as a mirror when it is turned off and can be simply used by customers in a conventional manner to try out make-up or try on jewelry. The panel 20 can be used as a display when it is on. The display can be used for advertising when it is not being used for image display. When it is being used for beauty enhancement, a digital image can be captured of the individual before make-up is applied as well as after make-up is applied. These images can then be displayed side by side on the display panel for viewing by the customer. The images can also be stored for future reference by the store, so when the customer returns the same make-up application can be repeated if desired, or different make-up may be applied and captured as a new image. These images could also be provided to the customer in hard copy from printer module 16 or on a compact disc (“CD”) or other storage medium for them to take home. The storage medium may be a compact disc (“CD”), floppy disk, magnetic tape, digital video disc (“DVD”) or the like. The built in camera 22 has zoom capability to capture enlarged views of “make-up” features.

Instead of actually applying make-up to a customer, computer software techniques may be used to apply make-up to the original or “before” image in order to create an enhanced image which can then be viewed by the customer. Many different make-up techniques may be applied quickly and easily in this manner, without having to physically apply the make-up to the customer. The customer can easily compare different make-up effects to decide which one is best, simply by comparing different enhanced images simultaneously on the display panel 20. If desired, a follow-up physical application of “make-up” could be applied for a finished look without going through numerous trials of application of a variety of “make-ups”. This will save a lot of time and money. Again, the images can be captured and archived by the store for future reference as well as providing a hard copy and/or CD to the customer.

Various make-up procedures for virtual application to a stored image may be stored in the local data storage module 18 for use by an operator of the system. Additionally, make-up enhancements may be available over the Internet 54 from a remote server 55, so that an operator can download them to computer 14 for selectively enhancing an image.

The same procedure may also be used by a person in their home without needing to visit a store or beauty shop, using a similar system or a home computer with a monitor having a built-in digital camera. The user can first capture an image of his or her face without make-up, and can then apply virtual make-up to the image on the home system/computer prior to physically applying the selected version of the make-up which was tested. Computer generated “make-up” items, as well as descriptive techniques of application could be obtained at a store or over the Internet. Advantageously, new make-up items may become available over the Internet to download to a home system/computer. This allows an individual the ability to have instant access to the latest make-up items on the market, without leaving their home. The individual may then choose to purchase selected items over the Internet after viewing the computer-generated make up application on their digital image. The same basic method can be used to shop for other consumer items such as jewelry, clothing, eyewear, hairstyles, surgical enhancements, cosmetic dentistry, and the like.

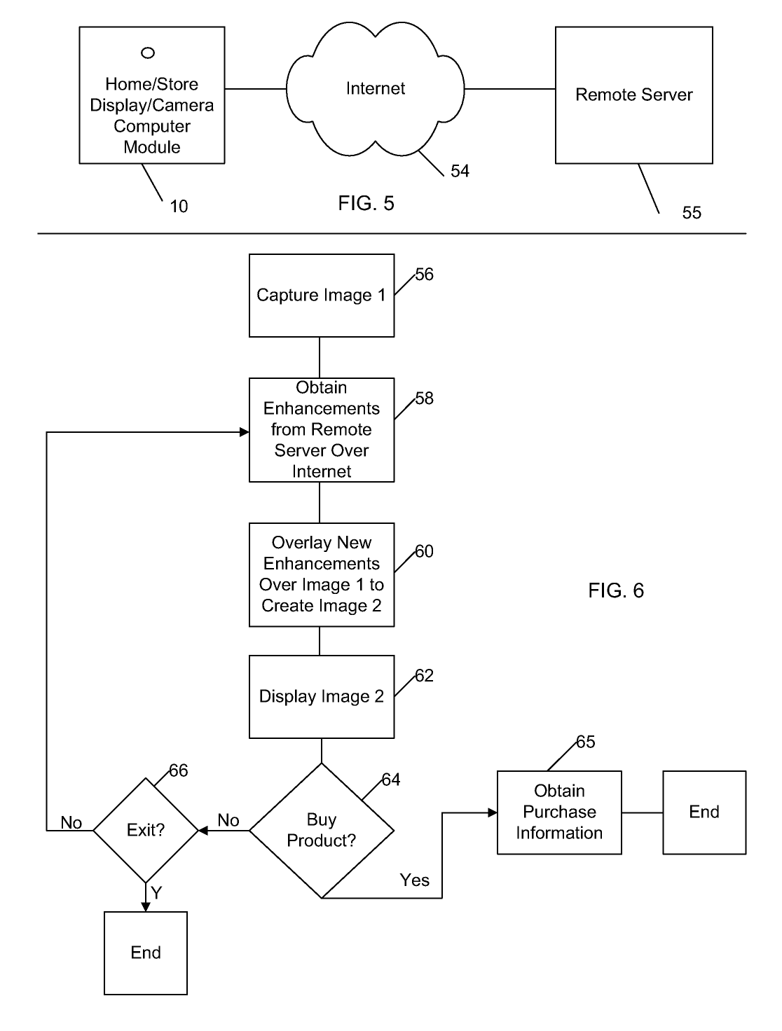

One method of shopping over the Internet using the image display system of FIG. 1 and communicating with a remote server as illustrated in FIG. 5 is illustrated in FIG. 6. As illustrated in FIG. 6, an image is first captured with the digital camera 22 (step 56). Selected enhancements are then obtained from the remote server 55 over the Internet 54 (step 58). The enhancements are then overlaid on the image (step 60), and the enhanced image is displayed (62). A customer can then choose to purchase a product (64), in which case address and payment information will be obtained (65), and the selected product will then be packaged and shipped to the customer. Alternatively, the customer may choose not to buy products, and may then exit the system (66) or return to step 58 to select different enhancements or make up effects.

Although the method and system is described above in connection with selecting make-up, exactly the same method and system may be used to test and select jewelry, either in a store or at home over the Internet. The hardware in this case can be identical to FIG. 1. The software will be similar to the software used in the make-up application. In a first embodiment, an initial image of a customer is taken, and one or more additional images are taken after trying on different jewelry. These images can be archived and/or given as a hard copy and/or a copy stored on a suitable storage medium to the customer.

Alternatively, rather than having the customer actually try on jewelry to create enhanced images, the method of FIG. 2 or 6 may be used for applying or overlaying the jewelry to the digital customer image. Jewelry items may be stored in the local storage module 18 for selection and application to the image, and may also be obtained over the Internet as in FIGS. 5 and 6. This method and system gives the customer the option of applying the latest jewelry images onto their own image in the privacy of their own home. Selected items can then be purchased via the Internet.

The system and method described above may also be used in shopping for clothing. The display panel 20 in this case may be full body length to provide a complete view of the selected clothing. An original digital image of the customer can be captured, followed by images of the same customer after trying on different clothing. The system can then be used to allow the customer to compare their image wearing different clothing side-by-side, as indicated in FIGS. 3A and 3B, which may help them select clothing to purchase. The images can be archived for future reference, or given as a hard copy and/or on a suitable storage medium such as a CD to the customer, who can show the images to family members for a second opinion before deciding which clothing to purchase.

Instead of the customer actual trying on different clothing, the same basic software may be used for applying the “digital” clothing to the digital customer image. The same technique may be used by the store in showing a customer a virtually created enhanced image of their appearance when wearing different clothing, as well as by the customer in their own home by retrieving selected clothing enhancements or overlays over the Internet. Again, this gives the customer the ability to apply (overlay) the latest clothing images from the Internet onto the customer's image in the privacy of their own home. These items can then be purchased via the Internet.

The same technology may also be used to assist in buying any item which is worn, such as eyeglasses, for example. In the simplest option, a digital image of a customer will be taken in a store and subsequent images will be taken while the customer tries various eyeglass styles. These images can be archived and/or given hard copy and/or CD to the customer. The customer can view different eyeglass styles side-by-side for better comparison than when they simply view different eyeglasses successively in a mirror. They can also take the images home for showing to others before deciding which style suits them best. As in the previous examples, computer software may alternatively be used to apply the “digital” eyewear to the digital customer image. This option may be provided in a store or the customer may be able to compare eyeglasses while shopping over the Internet, as in FIGS. 5 and 6. Again, this gives the customer the ability to apply (overlay) the latest eyewear images from the Internet onto the customer's image in the privacy of their own home. These items can then be purchased from a store or via the Internet.

Another optional use of the image capture system and method of FIGS. 1 to 4 is in a spa or beauty salon. In this case, “before” and “after” digital images may be taken with various hair/nail styles. These images can be archived and/or given hard copy and/or on a suitable storage medium such as a CD to the customer, potentially allowing a preferred style to be re-created more easily on a customer's next image. In an alternative method, computer software may be used to apply stored hair styles, nail styles or the like to the digital customer image, to allow the customer to select a desired hair style in advance, for example. The different styles may be stored locally in the system data storage module 18, or may be obtained from a remote server over the Internet as in FIG. 5. This gives the customer the ability to apply (overlay) the latest hair/nail style images from the Internet onto their image in the privacy of their own home. This will greatly assist the customer in choosing a spa or beauty salon as well as hair/nail styles.

Although the system is described above in connection with shopping for various accessories or services, it may also be designed to replace a conventional home vanity or bedroom mirror. In this case, the panel 20 may be a full length mirror to display full dress appearance. The user can take an initial image for reference purposes using the digital camera 22. For every special event they can take and store an image of their appearance for that event, showing what outfit was worn as well as other enhancements such as hair, nail, jewelry, and make-up. This will allow the user to archive their appearance for each function or party, for later reference when attending another function. The home vanity system will allow a user to ensure that the same outfit is not worn to similar events, or to compare a new outfit to previous outfits. The system in this option may also have the capability to apply various virtual enhancements to the user's image, retrieving enhancements either from local storage or over the Internet as described above for the previous embodiments. The home vanity system may also allow the user to purchase items over the Internet if desired.

Other possible applications of the same technology are in the fitness, dental, health, and cosmetic surgery fields. In each of these cases, actual before and after digital images may be taken, or an original image may be digitally enhanced to illustrate to the customer or individual the potential effect of various dental options, weight loss programs, fitness programs, cosmetic surgery options, and the like, using the same methods as described above in connection with FIGS. 1 to 6.

Although the system is described above in connection with enhancement of human images, it will be understood that the same system may also be used in other areas such as pet grooming, room decor, home re-modeling, landscaping, and the like. In the pet grooming field, an initial image of a pet will be obtained and stored, followed by images of the pet with different grooming styles, which may be taken after actual grooming or using computer applied virtual grooming enhancements to the pet's original image.

A hand-held or portable version of the image capture and display system of FIG. 1 may be used for other applications, such as digitally archiving the internal and external appearance of a home. Various digital enhancement features (windows, doors, roofing, paint, brick, stucco, etc.) may be retrieved over the Internet or by obtaining a CD from the various vendors, and then applied to the original image to allow the homeowner to select their preferred upgrades.

The image capture and display system described above can also allow landscape images to be archived and digitally enhanced to overlay new landscape effects over a current landscape for viewing by a user. The various digital plant, tree, grass, fence, brick, water, or other landscaping features may be obtained by a user over the Internet or on a CD provided by various vendors, allowing them to view the potential end result of any landscaping decision in advance.

The system may also be used to create enhanced art. An image may be made of an original drawing or painting, and the image may then be enhanced digitally to create a more realistic or aesthetically pleasing end result.

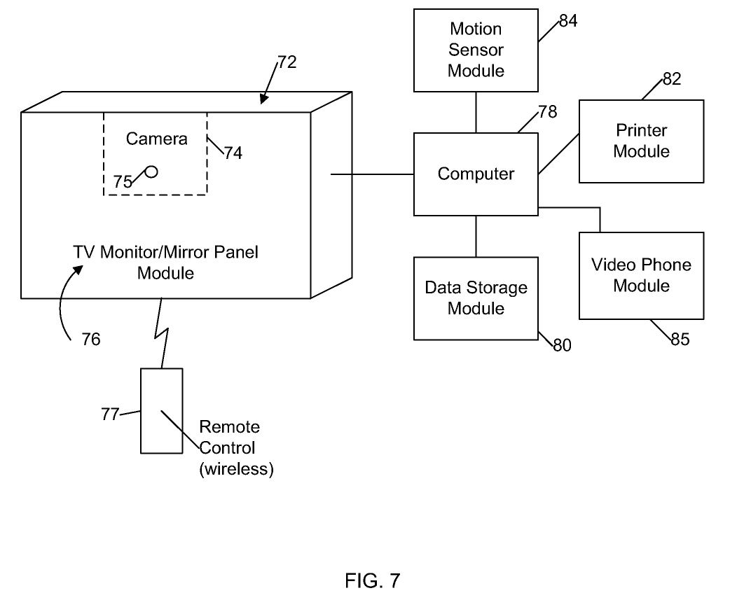

FIG. 7 illustrates an image capture and display system 70 according to another embodiment of the invention. In this embodiment, the display module 12 of FIG. 1 is replaced by a mirrored panel/television display module 72 having a mirrored display panel 76 and built-in digital camera module 74 with a lens 75 mounted in the panel 76 or in a frame surrounding the panel. A wireless or other remote control module 77 may be used for controlling operation of the system. The module 72 is connected to a computer 78 which will have a suitable control panel or controller (not illustrated). A data storage module 80 and printer module 82 are connected to the computer. Optionally, a motion sensor module 84 and a video phone module 85 are also connected to the computer. Although these modules are all shown separate from the flat panel/television display module 72 in FIG. 7, it will be understood that some or all of these modules may be integrated with module 72 in a single unit. Camera module may be a combined video and still digital camera, as in the previous embodiment. Printer module 82 may be a combined printer and scanner module, to allow images with enhancements to be scanned in for incorporation with an original image.

In this embodiment, the television with the mirrored flat panel monitor will add decoration as a mirror when it is not in use. The built-in camera module 74 will provide a means for capturing images of family events and the like, and may be used to take family group photos, individual photos, and the like. The camera may be a still camera, a video camera, or may be capable of recording both still and video images. Various stored images can be compared with later images or actual reflections of the same people. An attached video phone module 85, if used, can allow video phone calls to be made using the system. The same technology as described above may also be used to allow individuals to compare different images, such as a current and previous image, a current and digitally enhanced image, as well as images with different clothing, jewelry, make-up, hair styles, and the like. The camera module 74 may also be used to take images of the room and the resultant images may be enhanced by the user to add different room decor, paint or wall coverings, furniture items and the like in order to help them select new room decor. These effects can be accessed by the user over the Internet or on a CD or other storage medium obtained by a vendor of the various items of interest. This would allow the home user the opportunity to provide different digital images for helping them in remodeling.

Although a home system is described above in connection with FIG. 7, it will be understood that the display module in any of the embodiments described above may be a combination mirror and display screen/television monitor, whether used in a home, business, store, or elsewhere. In a store environment, the system may operate in a television or video mode to show videos or advertising of the product being sold on the display screen, and may be switched to a display mode to display images of a customer with various enhancements when a purchase decision is being made. When in mirror mode, the screen reverts to a conventional mirror appearance to reflect images. This can be used when a customer is trying on items such as clothing, jewelry, hair ornaments or hats, make-up, or the like. Images of the customer can be captured and stored while the panel 76 is in mirror mode.

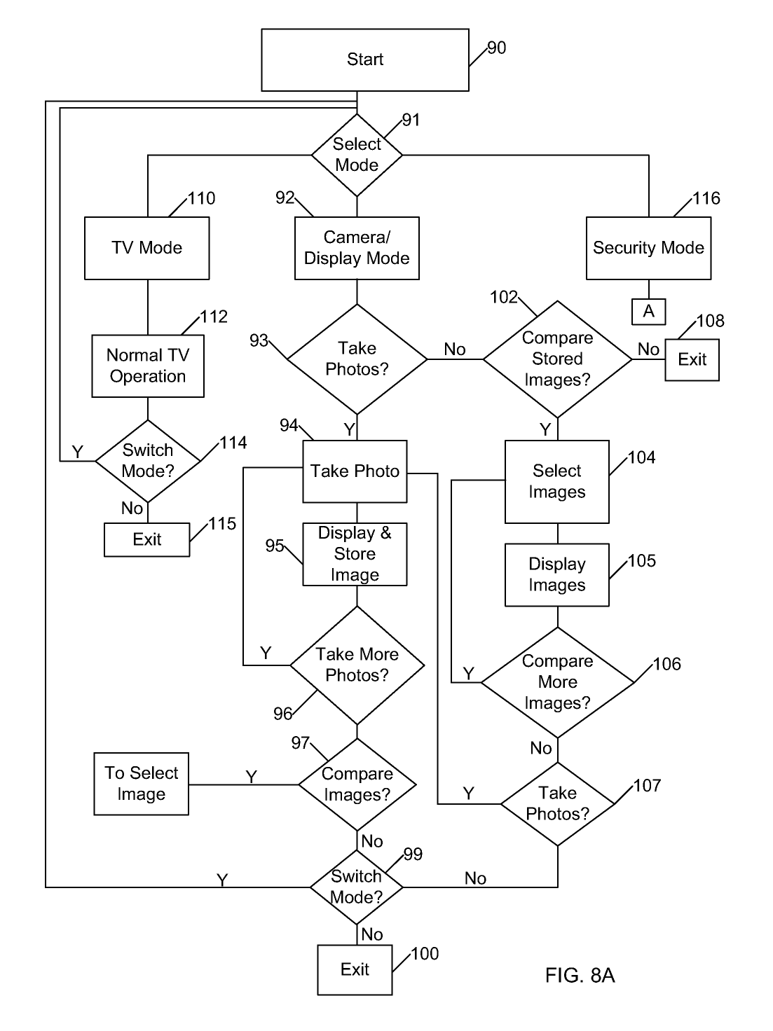

By adding a motion sensor 84 to the system as indicated in FIG. 7, the system may also be used for security, advertising, or simple monitoring purposes. Where the system is to be used for security, the camera may be hidden in the frame of the display panel, for example. FIGS. 8A and 8B illustrate a method of using the system of FIG. 7 in three possible different modes at the selection of the user. Initially, the panel 76 will have the appearance of a standard mirror and will reflect images. This will be more attractive than a standard TV monitor or panel. On initiation or start (90), the user will have the option of selecting a mode (91). In this case, the possible modes are camera/display mode 92, TV mode 110, and security or monitor mode 116. If camera/display mode is selected, the user can opt to take photographs (93), or compare stored images (102). If they wish to take photographs, they can operate the camera module to capture an image (94), and subsequently display and store the image (95). They can capture more images (96), or compare images (97). It will be understood that part of the image comparison option may include creation of enhanced images and displaying more than one image simultaneously, or displaying an enhanced image as well as a reflected image, using the methods illustrated in FIGS. 2 to 6 and described in more detail above.

Once the user has completed capturing, storing, and/or enhancing images, they may choose to switch to a different mode (99), or exit the system (100). If the user chooses to compare stored images (step 102) rather than create new images, they can select images for viewing from storage (step 104), and can display one or more images on the display screen (step 105). They can choose to select and compare more images (106), or to switch to taking photographs (107). When they are done, they can choose to switch mode 99 or exit the system (100 or 108).

The user may also select conventional TV mode 110 in step 91, in which case the display layer behind the mirror of the TV monitor will be operative and light will be transmitted through the mirror layer in normal TV operation (112). When the user has finished watching television, they may switch to a different mode (114), or exit the system (115).

If security/monitoring mode 116 is selected, the motion sensor module 84 will be activated to monitor the area within its field of view for movement, as illustrated in FIG. 8B. In this mode, the display is in mirror mode. If movement is detected (120), the camera module 74 is activated to take one or more photographs or to record video and to store the resultant image or images (122). The system will continue monitoring and taking images as long as the system is in the security mode, i.e. as long as the operator does not choose to exit the security mode (124). When security mode is no longer desired, the user operates the control panel to exit the system (125). The home owner can later review any images which were taken while the system was in security mode to detect burglary or break-ins, and possible use such images in identifying felons. Alternatively, the security images could be downloaded automatically to a security service or law enforcement personnel, and could also be used to activate an alarm.

In another embodiment, the system may be used in a store or the like and the security/monitoring mode may be used when customers are browsing at a store counter or the like. The motion sensor module 84 in this case activates the camera module to capture images of a potential customer, which can then be suitably enhanced and displayed to the same customer for advertising purposes.

The system with a built-in motion sensor and associated security mode can also be used for commercial and military high secure areas. The mirrored display with a built in digital camera and computer could quickly archive visitors. In addition, a quick comparison of threat images could be compared to the current image. Captured security images could be transmitted via a wired or wireless network to a security monitor at a remote location for further action.

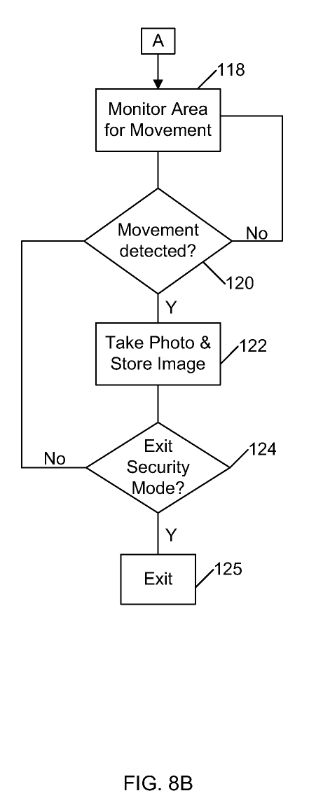

Although the system is described above in connection with relatively large scale image capture and display systems for use in the home, businesses, stores and the like, the same basic system may be scaled down for use in smaller, portable devices such as cameras, cell phones, palm pilots, portable digital assistants, game displays, and the like. FIG. 9 illustrates one example of a security application in which a number of small field units 130 are provided for use by security, emergency or law enforcement personnel, for example. Each field unit 130 can communicate with other field units and with a central processing unit or terminal 134 over a wireless network 132 such as the Internet.

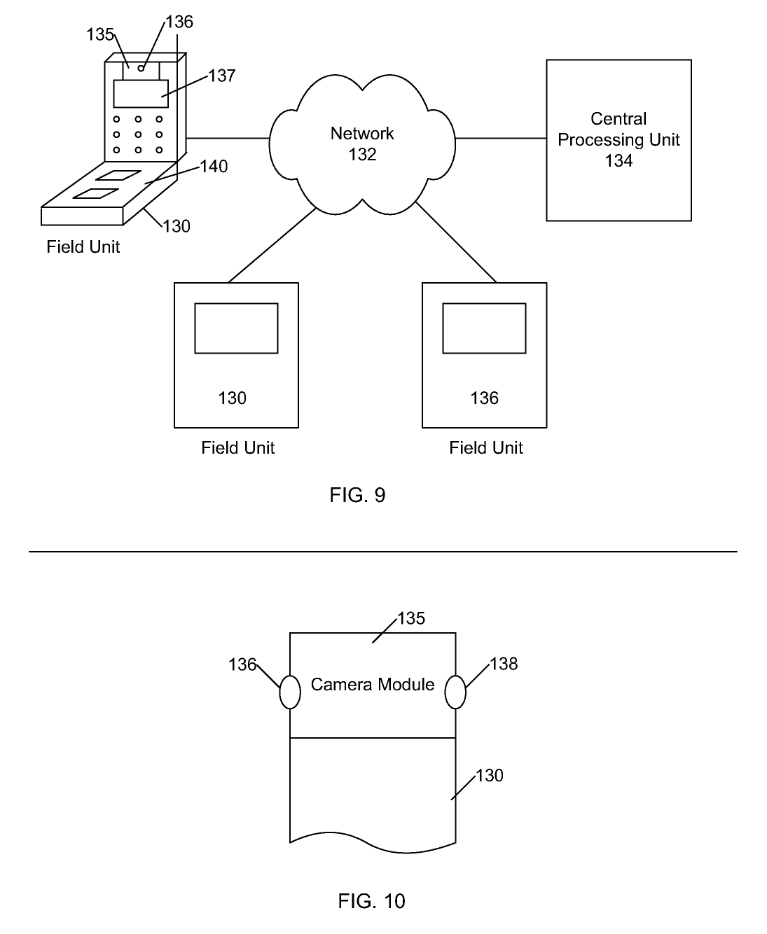

One field unit 130 is shown in an enlarged, flipped open view in FIG. 9, and will have a built-in communication device such as cell phone or portable digital assistant technology or the like, in addition to a camera module 135 and a mirrored display panel or screen 137. As illustrated in FIG. 10, the camera module may have two camera lenses 136, 138 facing in opposite directions, one towards the user and one away from the user. The camera module may be a still digital camera or a combination video and still digital camera. The base 140 of the unit may act as a compact for holding make-up for conventional use or in applying a disguise, with the operator using the display screen in mirror mode to view the effect of make-up application.

The security application of FIGS. 9 and 10 can allow users to obtain and compare images of subjects quickly and easily. An image of a possible suspect may be sent to the central processing unit, and compared side-by-side with images of actual criminals and/or terrorists in a data base, before sending back the images to the operator for further action.

In the above embodiments where enhanced images are created, one or more images may be taken of each subject prior to enhancement. Multiple images from different angles may be taken if desired, and software may be provided for creating images which can be rotated to check appearance from all directions, using software fill-in techniques, for example.

In the above embodiment, the built-in computer of the image capture and display system may communicate with a remote system over a network in any known manner, in order to download image enhancement features or software for applying such features, or to transmit images to a remote location. Some options for such communications are described below.

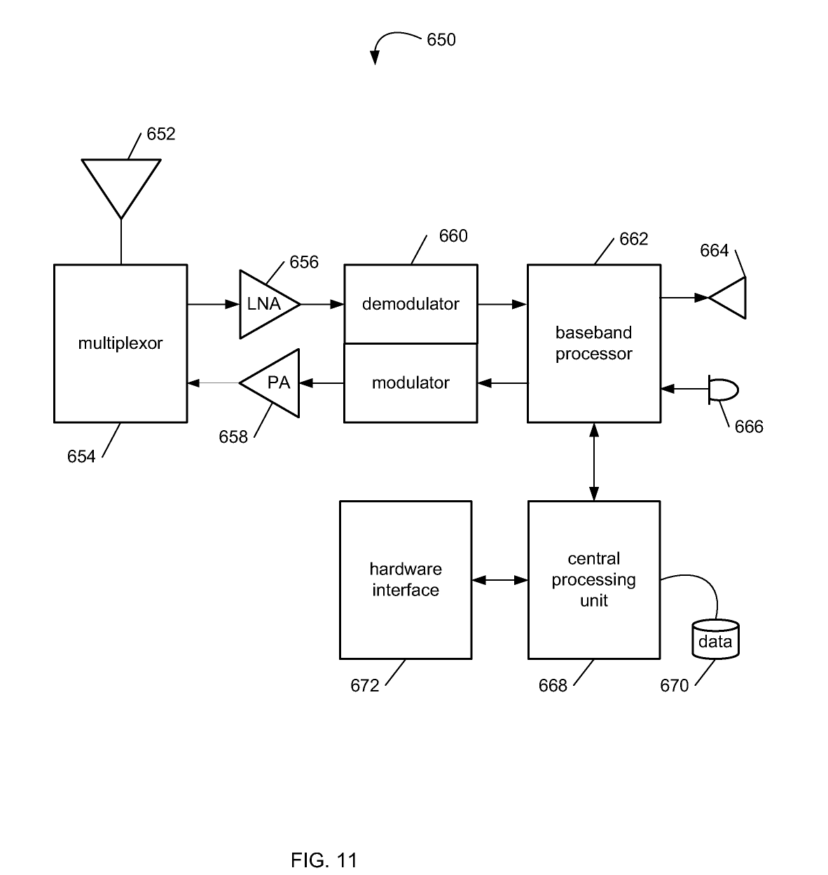

FIG. 11 is a block diagram illustrating an example of a wireless communication device 650 that may be used in connection with various embodiments described herein. For example, the wireless communication device 650 may be used in conjunction with the system of FIG. 5 to communicate with a remote server 55, or in the system of FIG. 9 to allow wireless communication between field units and a central processing unit. However, other wireless communication devices and/or architectures may also be used, as will be clear to those skilled in the art.

In the illustrated embodiment, wireless communication device 650 comprises an antenna 652, a multiplexor 654, a low noise amplifier (“LNA”) 656, a power amplifier (“PA”) 658, a modulation circuit 660, a baseband processor 662, and a speaker 664 and microphone 666. A central processing unit (“CPU”) 668 with a data storage area 670 is connected to the baseband processor, and a hardware interface 672 is connected to the CPU. In the wireless communication device 650, radio frequency (“RF”) signals are transmitted and received over the air by the antenna 652. In one embodiment, the antenna 652 may comprise one or more antennae. Multiplexor 654 performs a switching function to provide the antenna system with transmit and receive signal paths. In the receive path, received RF signals can be coupled from the multiplexor to the LNA 656 that amplifies the received RF signal and sends the amplified signal to the demodulator part of the modulation circuit 660.

Typical modulation circuit 660 will combine a demodulator and modulator in one integrated circuit (“IC”). The demodulator and modulator can also be separate components. In the incoming path, the demodulator strips away the RF carrier signal leaving a baseband receive audio signal, which is sent from the demodulator to the baseband processor 652.

If the received signal contains audio information, then baseband processor 652 decodes the signal and converts it to an analog signal. Then the signal is amplified and sent to the speaker 664. The baseband processor also receives analog audio signals from the microphone 666. These analog audio signals are converted to digital signals and encoded by the baseband processor 662. The baseband processor 662 also codes the digital signals for transmission and generates a baseband transmit audio signal that is routed to the modulator portion of the modulation circuit 660. The modulator mixes the baseband transmit audio signal with an RF carrier signal generating an RF transmit signal that is routed to the antenna system through power amplifier 658. The power amplifier amplifies the RF transmit signal and routes it to the multiplexor 654 where the signal is switched to the antenna port for transmission.

The baseband processor 662 is also communicatively coupled with the central processing unit 668. The central processing unit 668 has access to data storage area 670. The central processing unit 668 is preferably configured to execute instructions (i.e., computer programs or software) that can be stored in the data storage area 670. Computer programs can also be received from the baseband processor 662 and stored in the data storage area 670 or executed upon receipt. Such computer programs, when executed, enable the wireless communication device 650 to perform the various functions of the present invention as previously described. For example, data storage area 670 may include various software modules (not shown) such as image enhancement software that was previously described with respect to FIGS. 1 to 10.

In this description, the term “computer readable medium” is used to refer to any media used to provide executable instructions (e.g., software and computer programs) to the wireless communication device 650 for execution by the central processing unit 668. Examples of these media include the data storage area 670, microphone 666 (via the baseband processor 662), antenna 652 (also via the baseband processor 662), and hardware interface 672. These computer readable media are means for providing executable code, programming instructions, and software to the wireless communication device 650. The executable code, programming instructions, and software, when executed by the central processing unit 668, preferably cause the central processing unit 668 to perform the inventive features and functions previously described herein.

The central processing unit 668 is also preferably configured to receive notifications from the hardware interface 672 when new devices are detected by the hardware interface. Hardware interface 672 can be a combination electromechanical detector with controlling software that communicates with the CPU 668 and interacts with new devices. The hardware interface 672 may be a firewire port, a USB port, a Bluetooth or infrared wireless unit, or any of a variety of wired or wireless access mechanisms. Examples of hardware that may be linked with the device 650 include data storage devices, computing devices, headphones, microphones, and the like.

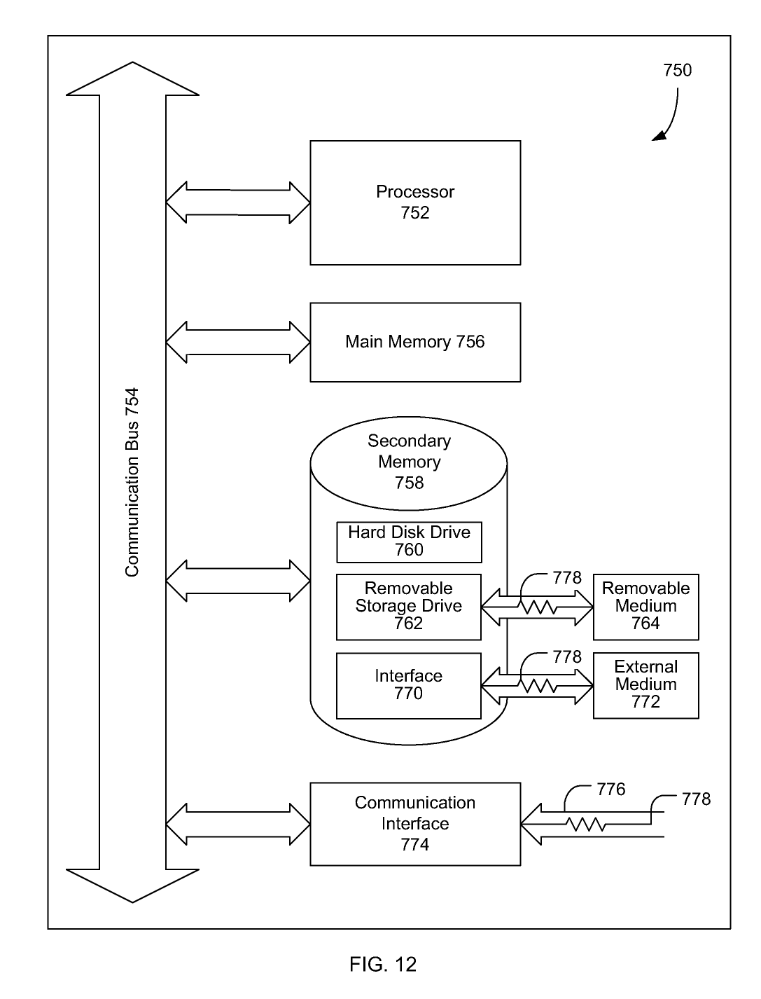

FIG. 12 is a block diagram illustrating an example computer system 750 that may be used in connection with various embodiments described herein. For example, the computer 14, 78 of FIGS. 1 and 7, respectively, may comprise a computer system 750 for controlling operation of the associated devices, such as the mirrored display/camera module of FIG. 1 or the TV monitor/mirror panel module of FIG. 7. However, other computer systems and/or architectures may be used, as will be clear to those skilled in the art.

The computer system 750 preferably includes one or more processors, such as processor 752. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 752.

The processor 752 is preferably connected to a communication bus 754. The communication bus 754 may include a data channel for facilitating information transfer between storage and other peripheral components of the computer system 750. The communication bus 754 further may provide a set of signals used for communication with the processor 752, including a data bus, address bus, and control bus (not shown). The communication bus 754 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 750 preferably includes a main memory 756 and may also include a secondary memory 758. The main memory 756 provides storage of instructions and data for programs executing on the processor 752. The main memory 756 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 758 may optionally include a hard disk drive 760 and/or a removable storage drive 762, for example a floppy disk drive, a magnetic tape drive, a compact disc (“CD”) drive, a digital versatile disc (“DVD”) drive, etc. The removable storage drive 762 reads from and/or writes to a removable storage medium 764 in a well-known manner. Removable storage medium 764 may be, for example, a floppy disk, magnetic tape, CD, DVD, etc.

The removable storage medium 764 is preferably a computer readable medium having stored thereon computer executable code (i.e., software) and/or data. The computer software or data stored on the removable storage medium 764 is read into the computer system 750 as electrical communication signals 778.

In alternative embodiments, secondary memory 758 may include other similar means for allowing computer programs or other data or instructions to be loaded into the computer system 750. Such means may include, for example, an external storage medium 772 and an interface 770. Examples of external storage medium 772 may include an external hard disk drive or an external optical drive, or and external magneto-optical drive.

Other examples of secondary memory 758 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 772 and interfaces 770, which allow software and data to be transferred from the removable storage unit 772 to the computer system 750.

Computer system 750 may also include a communication interface 774. The communication interface 774 allows software and data to be transferred between computer system 750 and external devices (e.g. printers), networks, or information sources. In the above embodiments, the built-in computer of the image capture and display system may communicate with a server over a network in any known manner, in order to download image enhancement features or software for applying such features, or to transmit security images to a central station. For example, computer software or executable code may be transferred to computer system 750 from a network server via communication interface 774. Examples of communication interface 774 include a modem, a network interface card (“NIC”), a communications port, a Personal Computer Memory Card International Association (“PCMCIA”) slot and card, an infrared interface, and an IEEE 1394 fire-wire, just to name a few.

Communication interface 774 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 774 are generally in the form of electrical communication signals 778. These signals 778 are preferably provided to communication interface 774 via a communication channel 776. Communication channel 776 carries signals 778 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 756 and/or the secondary memory 758. Computer programs can also be received via communication interface 774 and stored in the main memory 756 and/or the secondary memory 758. Such computer programs, when executed, enable the computer system 750 to perform the various functions of the present invention as previously described.

In this description, the term “computer readable medium” is used to refer to any media used to provide computer executable code (e.g., software and computer programs) to the computer system 750. Examples of these media include main memory 756, secondary memory 758 (including hard disk drive 760, removable storage medium 764, and external storage medium 772), and any peripheral device communicatively coupled with communication interface 774 (including a network information server or other network device). These computer readable mediums are means for providing executable code, programming instructions, and software to the computer system 750.

In an embodiment that is implemented using software, the software may be stored on a computer readable medium and loaded into computer system 750 by way of removable storage drive 762, interface 770, or communication interface 774. In such an embodiment, the software is loaded into the computer system 750 in the form of electrical communication signals 778. The software, when executed by the processor 752, preferably causes the processor 752 to perform the inventive features and functions previously described herein.

Those of skill in the art will appreciate that the various illustrative modules and method steps described in connection with the above described figures and the embodiments disclosed herein can often be implemented as electronic hardware, computer software, or combinations of both. To clearly illustrate this interchangeability of hardware and software, various illustrative modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions or steps can be moved from one module or step to another without departing from the invention.

Moreover, the various illustrative modules and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A combination image capture and display system, comprising:
a display module having a mirrored display panel facing in a first direction having a mirror layer and an image display layer disposed behind at least a portion of the mirror layer, the display panel being selectively operable to act as a mirror in a mirror mode or as an image display panel in a display mode;
a camera module integrated with the display module and having a lens facing outwardly from said panel; and
a computer connected to the display module and camera module for controlling operation of the camera module to capture images and switching of the display module between the mirror and display modes; and
a data storage module linked to the computer for storing captured images;
the computer being configured to control the display module to display selected images in the image display layer of the panel in the display mode.

2. The system as claimed in claim 1, wherein the display module, camera module, data storage module and computer are integrated in a single unit.

3. The system as claimed in claim 1, wherein the display module comprises a flat panel display.

4. The system as claimed in claim 1, wherein the entire display panel comprises a combined mirror and image display panel.

5. The system as claimed in claim 1, wherein the display panel has a first portion comprising a mirror only and a second portion comprising a combined mirror and image display portion.

6. The system as claimed in claim 1, wherein the computer is configured to control the image display layer in the display mode to display a stored image in a first area of the display panel and to display a mirror image in a second area of the display panel.

7. The system as claimed in claim 1, further comprising a motion sensor connected to the computer and positioned to monitor an area within the field of view of the camera, the computer being configured in a security mode to control the camera to capture an image on detection of motion within the monitored area.

8. The system as claimed in claim 1, wherein the computer is configured to enhance a first image taken by the camera to produce an enhanced second image, and to control the display module to display the first and second images.

9. The system as claimed in claim 2, wherein the single unit is integrated with a device selected from the group consisting of: a mobile phone; a personal digital assistant; a laptop computer; a desk top computer; a television; a make-up compact; and a game playing device.

10. An image capture and display method, comprising the steps of:
capturing images of subjects in an area within the field of view of a camera built into a mirrored display panel;
storing the captured images;
displaying selected images on the display panel in a display mode of the panel; and
reflecting images on the mirrored display panel in a mirror mode of the panel.

11. The method as claimed in claim 10, wherein the steps of capturing and storing images of subjects comprise capturing a first image of a subject, applying enhancements to the subject, and capturing a second image of the enhanced subject.

12. The method as claimed in claim 10, wherein the step of displaying selected images on the display panel in a display mode comprises controlling the display panel to operate a first area of the panel as an image display monitor and a second area of the panel as a mirror, and displaying a first selected image in the first area and reflecting an image of the subject in the second area of the mirrored display panel.

13. The method as claimed in claim 10, further comprising the steps of applying virtual enhancements to a stored original image to produce an enhanced image, storing the enhanced image, and displaying the enhanced image on the display panel.

14. The method as claimed in claim 13, wherein the original image and enhanced image are displayed simultaneously in different areas of the display panel.

15. The method as claimed in claim 14, wherein the first and second images are displayed side-by-side.

16. The method as claimed in claim 13, wherein the subject is a person and the step of applying virtual enhancements comprises adding at least one simulated element to the first image, the simulated element being selected from the group consisting of: make-up; hair; clothing; jewelry; and eyeglasses.

17. The method as claimed in claim 13, wherein the step of applying virtual enhancements comprises scanning an image having a selected enhancement and applying the enhancement from the scanned image to the first image.

18. An image capture and display method, comprising the steps of:
capturing an original image of a subject in an area within the field of view of a camera built into a display panel;
storing the original image;
applying enhancements to the original image to create an enhanced image; and
displaying the original and enhanced images simultaneously in separate areas of the display panel.

19. The method as claimed in claim 18, wherein the step of applying enhancements to the original image comprises accessing a remote server over a network, selecting image enhancements from a plurality of enhancements stored on the remote server, and applying the selected image enhancements to the original image.

20. The method as claimed in claim 18, further comprising the steps of switching the display panel into a mirror mode when images are not being displayed, and reflecting images on the display panel in the mirror mode.
